(19) United States
(12) Patent Application Publication
(10) Pub. No.: US 2023/0418429 A1
(43) Pub. Date: Dec. 28, 2023

(54) COMPUTER-READABLE RECORDING MEDIUM STORING INFORMATION PROCESSING PROGRAM, INFORMATION PROCESSING METHOD, AND INFORMATION PROCESSING APPARATUS

(71) Applicant: Fujitsu Limited, Kawasaki-shi (JP)

(72) Inventor: Yusuke HAMADA, Ota (JP)

(73) Assignee: Fujitsu Limited, Kawasaki-shi (JP)

(21) Appl. No.: 18/306,273

(22) Filed: Apr. 25, 2023

(30) Foreign Application Priority Data
Jun. 28, 2022 (JP) 2022-103976

(51) Int. Cl. G06F 3/04812

(52) U.S. Cl. CPC G06F 3/04812

(57) ABSTRACT

A recording medium stores a program for causing a computer to execute a process including: managing data to be used for processing of machine learning by a layered data structure of layers; displaying a display screen including a first display area that is made common to tasks in which designation of any one among one or more layer data groups included in each layer is received for the each layer, and a second display area that is an area for displaying lowermost layer data specified by designation of each layer data group and in which a display method is editable; holding definition information including a display method of each piece of the lowermost layer data in the second display area; and when lowermost layer data is designated, performing display in the second display area in accordance with the definition information based on the designated lowermost layer data.

### CROSS-REFERENCE TO RELATED APPLICATION

This application is based upon and claims the benefit of priority of the prior Japanese Patent Application No. 2022-103976, filed on Jun. 28, 2022, the entire contents of which are incorporated herein by reference.

### FIELD

The embodiments discussed herein are related to a computer-readable recording medium storing an information processing program, an information processing method, and an information processing apparatus.

### BACKGROUND

In recent years, machine learning has been actively used in a wide variety of fields including manufacturing and medical fields. For example, in machine learning, a machine learning model is caused to learn a predetermined task by using learning data. The predetermined task includes time-series prediction, image classification, voice recognition, or the like. For example, as the predetermined task, there are determination of a defect of a manufactured article from an image, determination of a health state of an employee based on attendance record data of the employee, and the like. After learning is completed, an estimation result is obtained by inputting unknown data related to the predetermined task to the learned machine learning model. Estimation accuracy of the machine learning model that has performed the estimation is evaluated by using the estimation result. As an example of machine learning, deep learning that uses a neural network (NN) as a learning model is known.

Japanese Laid-open Patent Publication No. 2018-005344 is disclosed as related art.

### SUMMARY

According to an aspect of the embodiments, a non-transitory computer-readable recording medium stores an information processing program for causing a computer to execute a process including: managing data to be used for processing of machine learning by a layered data structure of a plurality of layers; displaying a display screen that includes a first display area that is made common to a plurality of tasks in which designation of any one among one or a plurality of layer data groups included in each layer is received for the each layer, and a second display area that is an area for displaying lowermost layer data specified by designation of each layer data group and in which a display method is editable; holding definition information that includes a display method of each piece of the lowermost layer data in the second display area; and when lowermost layer data is designated, performing display in the second display area in accordance with the definition information based on the designated lowermost layer data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an information processing apparatus according to an embodiment;

FIG. 2 is a diagram illustrating an example of a GUI in which types are managed by tabs;

FIG. 3 is a diagram illustrating an example of a GUI on which types are displayed in a list;

FIG. 4 is a diagram illustrating an example of a GUI used for an image classification task;

FIG. 5 is a diagram illustrating an example of a GUI used for a voice recognition task;

FIG. 6 is a flowchart of GUI display processing performed by the information processing apparatus according to Embodiment 1;

FIG. 7 is a diagram illustrating an example of change of setting values in a custom GUI according to Embodiment 2; and

FIG. 8 is a hardware configuration diagram of the information processing apparatus.

### DESCRIPTION OF EMBODIMENTS

As described above, the range of use of machine learning has been rapidly expanding, and various end users may use machine learning. The end users include not only engineers who are used to the operation of machine learning, but also unskilled engineers. For this reason, it is important to provide a user interface that may be easily used by any end user.

As a common method for developing a machine learning model and providing the machine learning model to an end user, there is a graphical user interface (GUI). Although a GUI may be easily handled, there is a problem that the cost is high in the case of full scratch development in which development is newly performed without using an existing technique. To solve such problem of high cost, there is an application that provides a function (add-on) of adding a custom screen to a basic GUI.

As a technique for providing a user interface, there has been proposed a technique in which a rule for extending a user interface (UI) is added to a message and the message is transmitted from a Web server to a terminal, and the terminal having received the message interprets the rule and extends a UI function on a browser screen.

However, as described above, there are various tasks in machine learning. Development of a user interface for each task takes too much time and effort due to an increase in the number of development steps and the like. Accordingly, it is preferable to provide a general-purpose GUI in which various tasks may be comprehensively handled and a custom screen may be added in order to meet individual needs, but it is difficult for the current user interface of machine learning to meet such demands. For this reason, in machine learning of related art, it has been difficult to improve convenience for an end user in machine learning.

In consideration of the above-described circumstances, an object of the disclosed technique is to provide an information processing program, an information processing method, and an information processing apparatus that improve convenience for an end user in machine learning.

Hereinafter, embodiments of an information processing program, an information processing method, and an information processing apparatus disclosed in the present application will be described in detail based on the drawings. The following embodiments are not intended to limit the information processing program, the information processing method, and the information processing apparatus disclosed in the present application.

### EMBODIMENT 1

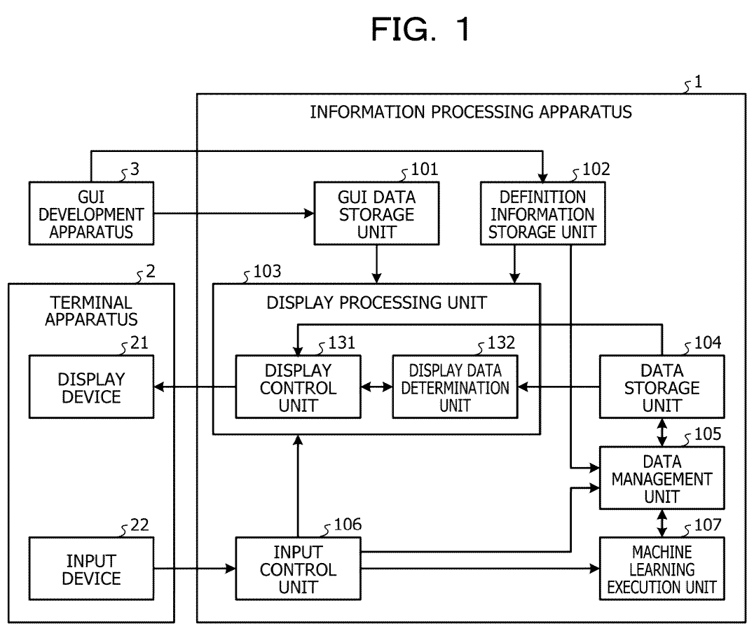

FIG. 1 is a block diagram of an information processing apparatus according to an embodiment. As illustrated in FIG. 1, an information processing apparatus 1 according to the present embodiment is coupled to a terminal apparatus 2 and a GUI development apparatus 3.

The GUI development apparatus 3 is an information processing apparatus used by an application developer who develops an application that operates using a machine learning model. The application developer uses the GUI development apparatus 3 and develops a GUI that is a user interface corresponding to its own application used in machine learning. This GUI includes an area common to tasks and a custom GUI that is an area different for each task and performs display corresponding to individual tasks. The application developer uses a layered data structure common to various tasks, uses the area common to tasks as it is, and develops a custom GUI for its own application.

In the present embodiment, as the layered data structure, layer data of datasets, types, and files are included in order from the upper layer. Datasets are data groups for performing learning, inference, and evaluation in machine learning related to a specific task.

Types are classifications of data included in each dataset. In the present embodiment, for example, there are types of data such as inference input data, inference result data, evaluation input data, and evaluation result data. Inference input data is data used when a machine learning model is caused to perform inference. Inference result data is output data corresponding to an inference result obtained by a machine learning model to which inference input data is input. Evaluation input data is data used for inference performance evaluation of a learned machine learning model, and includes correct answer data. Evaluation result data is data indicating an evaluation result of a machine learning model using evaluation input data.

Files are a file group of data included for each type in each dataset. A file may be further layered by a directory or the like.

Datasets, types, and files may be similarly determined for data related to any task as long as the data is used for machine learning, and may be used as layer data common to various tasks.

The terminal apparatus 2 is an apparatus for causing the information processing apparatus 1 to execute learning of a machine learning model, inference using the learned machine learning model, and evaluation of the inference accuracy of the learned machine learning model. The terminal apparatus 2 is an apparatus used by an end user who uses machine learning. In the following description, an end user is referred to as a user. The terminal apparatus 2 includes a display device 21 and an input device 22.

For example, the display device 21 is a monitor or the like. The display device 21 displays a result of machine learning processing by the information processing apparatus 1, and the like. The display device 21 displays a user interface of machine learning processing.

For example, the input device 22 is a keyboard, a mouse, or the like. A user uses the input device 22 and inputs an execution instruction of machine learning processing and data to be used for machine learning processing. For example, the input device 22 receives an instruction from the user and inputs inference input data and evaluation input data to the information processing apparatus 1. The input device 22 receives an instruction from the user and inputs an execution instruction of inference and an execution instruction of evaluation of a machine learning model to the information processing apparatus 1. The user may input various execution instructions by using the GUI according to the present embodiment displayed on the display device 21.

The information processing apparatus 1 generates a GUI to be used in machine learning and displays the GUI on the display device 21 of the terminal apparatus 2. The information processing apparatus 1 executes learning of a machine learning model, inference using the machine learning model, and inference accuracy evaluation of the machine learning model. As illustrated in FIG. 1, the information processing apparatus 1 includes a GUI data storage unit 101, a definition information storage unit 102, a display processing unit 103, a data storage unit 104, a data management unit 105, an input control unit 106, and a machine learning execution unit 107.

The GUI data storage unit 101 receives and stores data of a GUI developed by the GUI development apparatus 3. The GUI data storage unit 101 stores data of a GUI that performs display corresponding to layer data having a layered data structure common to tasks. For example, the GUI data storage unit 101 stores data of a GUI that is made common to datasets. In the GUI that is made common to datasets, a GUI related to types is also made common, and a GUI related to files is also made common.

The definition information storage unit 102 receives, from the GUI development apparatus 3, input of definition information related to a custom GUI developed by an application developer using the GUI development apparatus 3, and stores the definition information. For example, the definition information storage unit 102 holds definition information indicating a storage destination for storing each file for each type in layer data having a layered data structure. The definition information may be information that designates a layered structure such as a directory as a storage destination of each file for each type.

The definition information storage unit 102 defines a custom GUI corresponding to the selection state of a type and a file. For example, the definition information storage unit 102 stores information on a correspondence relationship with a custom GUI used for display corresponding to a combination of a type and a file. The definition information storage unit 102 stores definition information on a display method including what kind of information is to be displayed in each custom GUI. For example, the definition information storage unit 102 stores definition information indicating that, in a case where inference input data is designated as a type and a predetermined directory is designated as a file, a list of images whose type is inference input data and which are stored in the predetermined directory is to be displayed in a corresponding GUI. As another example, the definition information storage unit 102 stores definition information indicating that, in the case where inference input data is designated as a type and a predetermined directory is designated as a file, a list of texts whose type is inference input data and which are stored in the predetermined directory is to be displayed in a corresponding GUI.

The input control unit 106 receives, from the input device 22, input of a dataset of various data to be used for machine learning, such as learning data, inference input data, and evaluation input data. The learning data, inference input data, and evaluation input data are data used in machine learning regardless of the kind of a task, and may be said to be the kind of data common to tasks. The input control unit 106 outputs the input various data to the data management unit 105.

The input control unit 106 receives, from the input device 22, input of various execution instructions such as an execution instruction of learning of a machine learning model, an execution instruction of inference using the machine learning model, and an execution instruction of inference accuracy evaluation of the machine learning model. The learning, inference, and evaluation are processing executed in machine learning regardless of the kind of a task, and the execution instructions thereof may be said to be execution instructions common to tasks. The input control unit 106 outputs the input various execution instructions to the machine learning execution unit 107.

The input control unit 106 receives input of an operation instruction for a GUI displayed on the display device 21, such as movement of a mouse pointer. The input control unit 106 outputs the input operation instruction to a display control unit 131.

The data storage unit 104 stores various data related to machine learning. For example, the data storage unit 104 holds inference input data, inference result data, evaluation input data, and evaluation result data as layer data by using a layered data structure. The layered data structure included in the data storage unit 104 is generated by the data management unit 105. For example, the data storage unit 104 holds a data group to be used for a predetermined task with datasets in the uppermost layer. The data storage unit 104 stores data classified by type in a layer under the datasets. The data storage unit 104 manages the data belonging to each type as files. The data storage unit 104 may manage the files in a further layered structure using directories or the like.

For example, the data storage unit 104 uses a layered data structure that is made common to tasks, and manages layer data to be used for machine learning processing. The layer for datasets is an example of a “first layer”, the layer for types is an example of a “second layer”, and the layer for files is an example of a “third layer”. The data storage unit 104 manages data in a layered data structure of the first layer, the second layer, and the third layer that is the lowermost layer.

The machine learning execution unit 107 receives input of various execution instructions from the input control unit 106. In a case of an execution instruction of learning of a machine learning model, the machine learning execution unit 107 requests the data management unit 105 to acquire learning data. After that, the machine learning execution unit 107 acquires the learning data from the data management unit 105 and executes learning of the machine learning model by using the acquired learning data.

In a case of an execution instruction of inference using a machine learning model, the machine learning execution unit 107 requests the data management unit 105 to acquire inference input data. After that, the machine learning execution unit 107 acquires the inference input data from the data management unit 105, inputs the acquired inference input data to the machine learning model to cause the machine learning model to perform inference, and acquires inference result data output from the machine learning model. After that, the machine learning execution unit 107 outputs the inference result data to the data management unit 105 and causes the data storage unit 104 to store the inference result data.

In a case of an execution instruction of inference accuracy evaluation of a machine learning model, the machine learning execution unit 107 requests the data management unit 105 to acquire evaluation input data. After that, the machine learning execution unit 107 acquires the evaluation input data from the data management unit 105. Next, the machine learning execution unit 107 inputs the acquired evaluation input data to the machine learning model to cause the machine learning model to perform inference, and acquires an inference result output from the machine learning model. Next, the machine learning execution unit 107 compares the acquired inference result with correct answer data and evaluates the inference accuracy of the machine learning model. After that, the machine learning execution unit 107 outputs evaluation result data to the data management unit 105 and causes the data storage unit 104 to store the evaluation result data.

Inference result data and evaluation result data are data generated when processing of machine learning is performed regardless of the kind of a task, and may be said to be data common to tasks. For example, processing of storing or calling these pieces of data may be made common to tasks.

The data management unit 105 stores data in the data storage unit 104 and manages the data stored in the data storage unit 104. The data management unit 105 receives input of various data from the input control unit 106. Next, the data management unit 105 acquires, from the definition information storage unit 102, definition information related to storage such as file names and storage locations in a layered data structure corresponding to the type of data. For example, in a case of inference input data, the data management unit 105 acquires definition information indicating that files are to be stored in directories D1 and D2 and definition information indicating that file names are files F1 to Fn or the like. After that, the data management unit 105 assigns file names and stores the data in the designated storage locations in the data storage unit 104 in accordance with the acquired definition information. By storing data in the data storage unit 104 in accordance with definition information, the data management unit 105 may store the data in the data storage unit 104 in accordance with a layered data structure designed by an application developer.

The data management unit 105 receives, from the machine learning execution unit 107, an acquisition instruction of various data such as learning data, inference input data, or evaluation input data. The data management unit 105 reads the designated data from the data storage unit 104 and outputs the data to the machine learning execution unit 107.

The data management unit 105 receives, from the machine learning execution unit 107, an instruction to store various data such as inference result data or evaluation result data. Next, the data management unit 105 acquires, from the definition information storage unit 102, definition information related to storage of the acquired data. The data management unit 105 stores the data instructed to be stored by the machine learning execution unit 107 in the data storage unit 104 in accordance with the acquired definition information. Accordingly, the data management unit 105 may also store data generated by the machine learning execution unit 107 in the data storage unit 104 as layered data having a layered data structure designed by an application developer.

The display processing unit 103 displays a GUI on the display device 21 included in the terminal apparatus 2. The display processing unit 103 includes the display control unit 131 and a display data determination unit 132.

The display data determination unit 132 receives, from the display control unit 131, input of information on datasets, types, and files indicating a storage destination of data to be displayed on a custom GUI. Next, the display data determination unit 132 refers to definition information related to display held in the definition information storage unit 102. For example, in the definition information related to display, a custom GUI that is a display destination of data stored in a predetermined directory is designated. The display data determination unit 132 determines whether there is data satisfying the condition designated by the definition information at the designated storage destination of datasets, types, and files in the data storage unit 104. Next, when there is data satisfying the condition, the display data determination unit 132 notifies the display control unit 131 of information on the data and a display method of the data.

The display control unit 131 receives input of an operation instruction from the input control unit 106. For example, the display control unit 131 receives an instruction to display a GUI to be used for machine learning from the input control unit 106. Next, the display control unit 131 acquires a GUI to be used for displaying each piece of layered data from the GUI data storage unit 101. The display control unit 131 transmits the acquired GUI to the display device 21 and causes the display device to display the GUI.

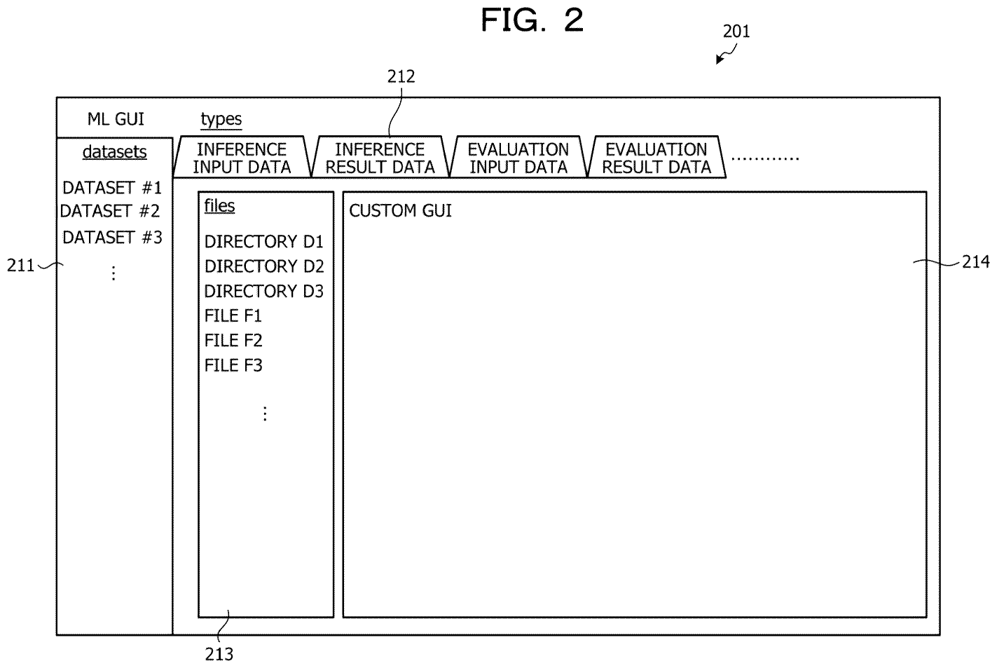

FIG. 2 is a diagram illustrating an example of a GUI in which types are managed by tabs. For example, the display control unit 131 causes the display device 21 to display a GUI 201 illustrated in FIG. 2. In this case, the display control unit 131 causes the display device to display the GUI 201 including a dataset information display area 211, type-specific tabs 212, a file information display area 213, and a custom GUI 214.

The kind of a dataset is displayed in the dataset information display area 211. By a user using a mouse or the like and selecting one from among the datasets displayed in the dataset information display area 211, the display control unit 131 causes the GUI 201 to display data related to the selected dataset.

The display control unit 131 causes the GUI 201 to display the type-specific tabs 212, which are tabs for selecting a type to be displayed on a GUI. By using a mouse or the like and selecting one from among the type-specific tabs 212, the user may cause the GUI 201 to display data having the type corresponding to the type-specific tab 212.

The display control unit 131 displays, in the file information display area 213, the files included in the type-specific tab 212 selected by the user. In addition to the file names assigned to data, the display control unit 131 displays directories as files.

In a case where the user uses a mouse or the like and selects one from among the files displayed in the file information display area 213, the display control unit 131 notifies the display data determination unit 132 of information on the selected file together with information on the type and dataset including the file. After that, the display control unit 131 acquires, from the display data determination unit 132, data to be displayed in the custom GUI 214 corresponding to the designated file and the display method. The display control unit 131 displays the acquired data in the custom GUI 214 in accordance with the designated display method. For example, in a case where a file of inference input data for performing processing of machine learning using images is selected, the display control unit 131 displays various images to be used for inference in the custom GUI 214.

The dataset information display area 211, the type-specific tabs 212, and the file information display area 213 are display areas that are made common to tasks. For example, these display areas are an example of a “first display area that is made common to a plurality of tasks in which designation of any one among one or a plurality of layer data groups included in each layer is received for each layer”. The first display area receives designation of any one among first layer data groups included in the first layer and designation of any one among second layer data groups included in the designated first layer data group in the second layer. The first display area receives designation of lowermost layer data included in the designated second layer data group in the third layer. The custom GUI 214 is a unique display area dependent on a task. For example, the custom GUI 214 is an example of a “second display area that is an area for displaying the lowermost layer data specified by the designation of each layer data group and in which the display method is editable”. The GUI 201 is an example of a display screen including the first display area and the second display area.

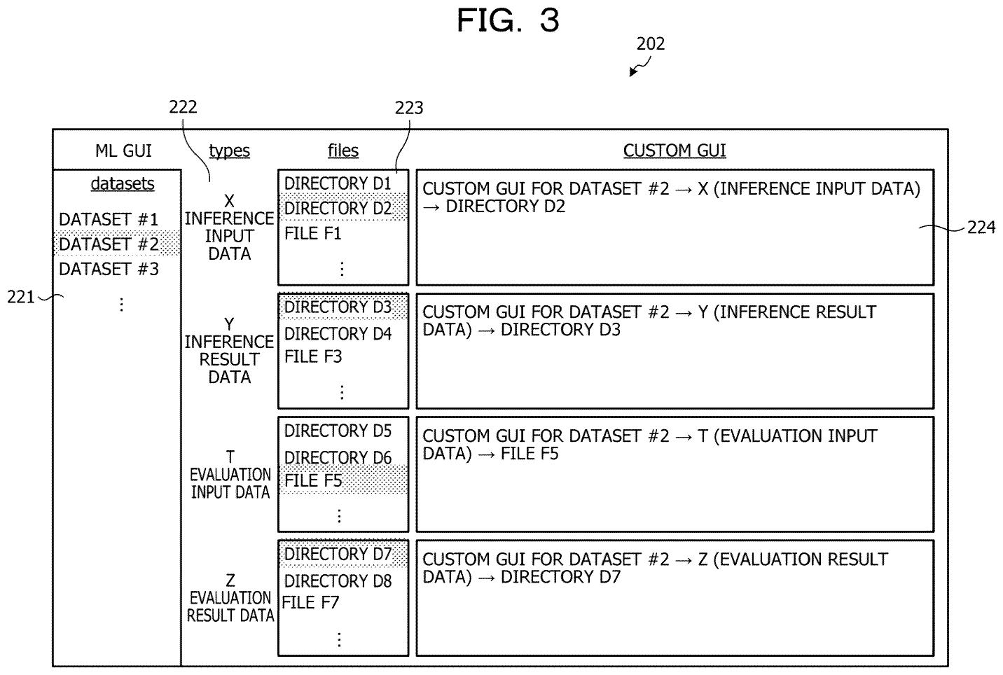

FIG. 3 is a diagram illustrating an example of a GUI on which types are displayed in a list. Although the display control unit 131 displays the file information display area 213 and the custom GUI 214 related to the selected type and does not display information of the other types except for tabs in FIG. 2, the display control unit may display information of each type in a list as illustrated in FIG. 3.

In this case, for example, the display control unit 131 causes the display device to display a GUI 202 including a dataset information display area 221, a list-of-types display area 222, a file information display area 223, and a custom GUI 224.

Similar to the case in FIG. 2, the kind of a dataset is displayed in the dataset information display area 221. By a user using a mouse or the like and selecting one from among the datasets displayed in the dataset information display area 211, the display control unit 131 causes the GUI 202 to display data related to the selected dataset.

The display control unit 131 causes the list-of-types display area 222 to display, in a list, information on the types included in the selected dataset. In FIG. 3, a symbol is assigned to each type, and the display control unit 131, the display data determination unit 132, and the data management unit 105 manage the kinds of types by using the assigned symbols. In this case, the display control unit 131 manages inference input data as X, inference result data as Y, evaluation input data as T, and evaluation result data as Z.

The display control unit 131 displays the files included in each type in the file information display area 223. In addition to the file names assigned to data, the display control unit 131 displays directories as files.

In a case where the user uses a mouse or the like and selects one from among the files displayed in the file information display area 223 for each type, the display control unit 131 notifies the display data determination unit 132 of information on the selected file together with information on the type and dataset including the file. After that, the display control unit 131 acquires, from the display data determination unit 132, data to be displayed in the custom GUI 224 corresponding to the designated file and the display method. The display control unit 131 causes the custom GUI 224 to display the acquired data by the designated display method. For example, in the case of FIG. 3, the display control unit 131 displays, in the custom GUI 224 corresponding to X (inference input data), the data corresponding to directory D2 of X (inference input data) of dataset #2.

The dataset information display area 221, the list-of-types display area 222, and the file information display area 223 are display areas that are made common to tasks. For example, these display areas are an example of the “first display area that is made common to a plurality of tasks in which designation of any one among one or a plurality of layer data groups included in each layer is received for each layer”. The first display area receives designation of any one among first layer data groups included in the first layer and designation of any one among second layer data groups included in the designated first layer data group in the second layer. The first display area receives designation of lowermost layer data included in the designated second layer data group in the third layer. The custom GUI 224 is a unique display area dependent on a task. For example, the custom GUI 224 is an example of the “second display area that is an area for displaying the lowermost layer data specified by the designation of each layer data group and in which the display method is editable”. The GUI 202 is an example of the display screen including the first display area and the second display area.

As described above, kinds of data used for machine learning, layered data structure, and various execution instructions may be made common to tasks. For this reason, in a GUI displayed on the display device 21 by the display control unit 131, display of a layered data structure, display of data in each layer, and display for inputting an execution instruction may be made common to tasks. Accordingly, the display control unit 131 uses the display common to tasks for the display of a GUI to be used for machine learning other than a custom GUI, and causes the custom GUI to display the display content dependent on a task. Therefore, when a GUI is developed, an application developer only has to use common components for portions of the GUI common to tasks and design and develop a custom GUI according to a task.

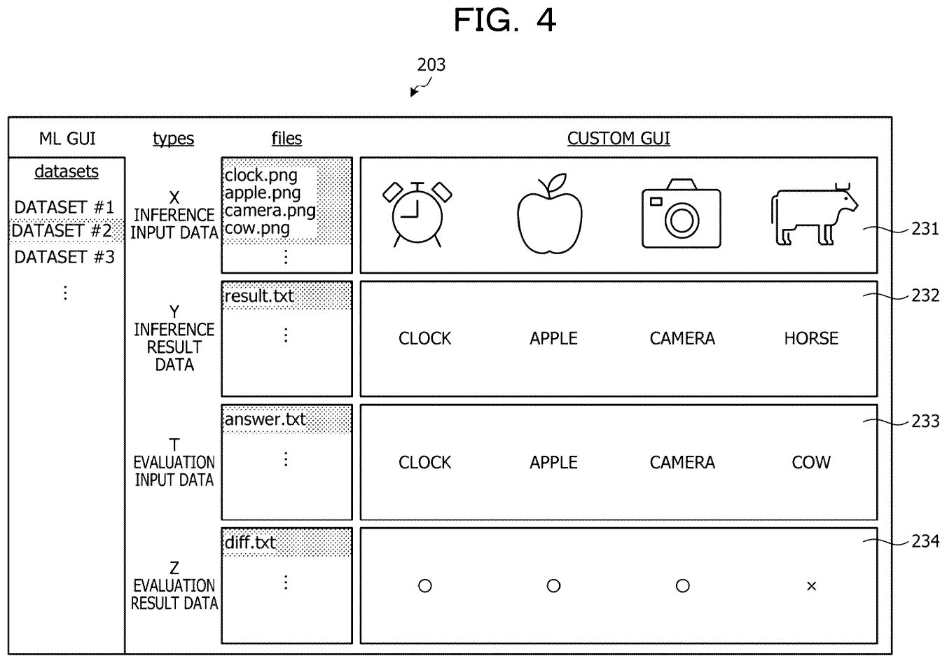

FIG. 4 is a diagram illustrating an example of a GUI used for an image classification task. An example of development and use of an application that uses processing of machine learning will be described with reference to FIG. 4. In this case, data included in dataset #2 is data related to an image classification task.

An application developer develops a custom GUI. For example, the application developer defines a custom GUI corresponding to the selection state of type and file. For example, the application developer defines a custom GUI corresponding to type “X (inference input data)” and file “all files” for dataset #2 such that the images of the file names of all files of type X are displayed in a list. Alternatively, the application developer may define a custom GUI corresponding to type “X” and file “directory D1” such that the images stored in directory D1 are displayed in a list. The application developer defines a custom GUI corresponding to type “X” and file “result.txt” such that the words stored in result.txt are displayed in a list.

Next, a user of the application uses the input device 22 and inputs inference input data to the information processing apparatus 1, and uploads the inference input data to the section of type X in dataset #2. The data management unit 105 acquires the inference input data from the input control unit 106, and stores the inference input data at the position of type X of dataset #2 in the data storage unit 104 in accordance with the definition information. After that, when the user uses a GUI 203 and designates dataset #2, type X, and file “all files”, the display data determination unit 132 notifies the display control unit 131 of displaying, in a list, the images of all files of type X of dataset #2. As illustrated in FIG. 4, the display control unit 131 causes a custom GUI 231 to display, in a list, the images of all files of type X of dataset #2.

After that, when the user uses the input device 22 and inputs an execution instruction of inference to the information processing apparatus 1, the machine learning execution unit 107 inputs the inference input data stored in the data storage unit 104 to a machine learning model and executes inference. Next, the data management unit 105 uses the definition information and stores inference result data output from the machine learning execution unit 107 as result.txt of type Y (inference result data) of dataset #2 in the data storage unit 104. After that, when the user uses the GUI 203 and designates dataset #2, type Y, and file “result.txt”, the display data determination unit 132 notifies the display control unit 131 of displaying, in a list, the words included in result.txt in type Y of dataset #2. As illustrated in FIG. 4, the display control unit 131 causes a custom GUI 232 to display, in a list, the words included in result.txt in type Y of dataset #2.

Next, the user uses the input device 22 and inputs evaluation input data to the information processing apparatus 1, and uploads the evaluation input data to the section of type T (evaluation input data) in dataset #2. The data management unit 105 acquires the evaluation input data from the input control unit 106, and stores the evaluation input data at the position of type T of dataset #2 in the data storage unit 104 in accordance with the definition information. For example, at this time, the data management unit 105 stores the correct answer data for the inference input data as answer.txt in the data storage unit 104. After that, the user uses the GUI 203 and designates dataset #2, type T, and file “answer.txt”. The display data determination unit 132 notifies the display control unit 131 of displaying, in a list, the words included in answer.txt in type T of dataset #2. As illustrated in FIG. 4, the display control unit 131 causes a custom GUI 233 to display, in a list, the words included in answer.txt in type T of dataset #2.

After that, the user uses the input device 22 and inputs an execution instruction of inference accuracy evaluation of the machine learning model to the information processing apparatus 1. In response to this, the machine learning execution unit 107 inputs the evaluation input data stored in the data storage unit 104 to the machine learning model, compares the output data thereof with the correct answer data, and executes inference accuracy evaluation. After that, the data management unit 105 uses the definition information and stores evaluation result data output from the machine learning execution unit 107 as diff.txt of type Z (evaluation result data) of dataset #2 in the data storage unit 104. After that, the user uses the GUI 203 and designates dataset #2, type Z, and file “diff.txt”. The display data determination unit 132 notifies the display control unit 131 of displaying, in a list, the evaluation results included in diff.txt in type Z of dataset #2. As illustrated in FIG. 4, the display control unit 131 causes a custom GUI 234 to display, in a list, the evaluation results included in diff.txt in type Z of dataset #2, in accordance with the display method instructed by the display data determination unit 132. For example, the display control unit 131 causes the custom GUI 234 to display the results of comparison between the words displayed in the custom GUI 232 of type Y and the words displayed in the custom GUI 233 of type T by using “o” or “x”.

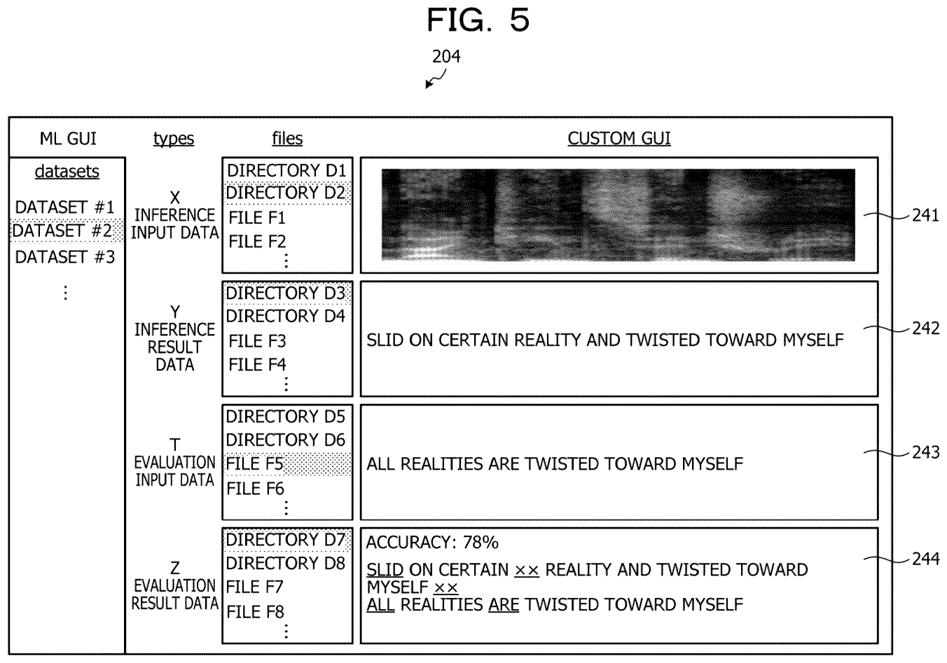

FIG. 5 is a diagram illustrating an example of a GUI used for a voice recognition task. Next, an example of display of a GUI in the case of a voice recognition task will be described with reference to FIG. 5. In this case, data included in dataset #2 is data related to a voice recognition task.

For example, the data management unit 105 stores input voice data that is inference input data in directory D2 in type X of dataset #2 in the data storage unit 104. The display control unit 131 causes a custom GUI 241 corresponding to type X of dataset #2 to display a spectrogram obtained by imaging the voice data stored in directory D2.

The data management unit 105 stores inference result data output from the machine learning execution unit 107 in directory D3 in type Y of dataset #2 in the data storage unit 104. The display control unit 131 causes a custom GUI 242 corresponding to type Y of dataset #2 to display, in text, the inference result data stored in directory D3.

The data management unit 105 stores input evaluation input data in type T of dataset #2 in the data storage unit 104. At this time, the data management unit 105 stores the correct answer data included in the evaluation input data as file F5. The display control unit 131 causes a custom GUI 243 corresponding to type T of dataset #2 to display, in text, file F5 in type T.

The data management unit 105 stores evaluation result data output from the machine learning execution unit 107 in directory D7 in type Z of dataset #2 in the data storage unit 104. The display control unit 131 causes a custom GUI 244 corresponding to type Z of dataset #2 to display the evaluation result data stored in directory D7, in accordance with the display method instructed by the display data determination unit 132. In this case, the display control unit 131 causes the custom GUI to display the evaluation result and the correct answer data side by side such that the different portions are identifiable, and display the recognition accuracy.

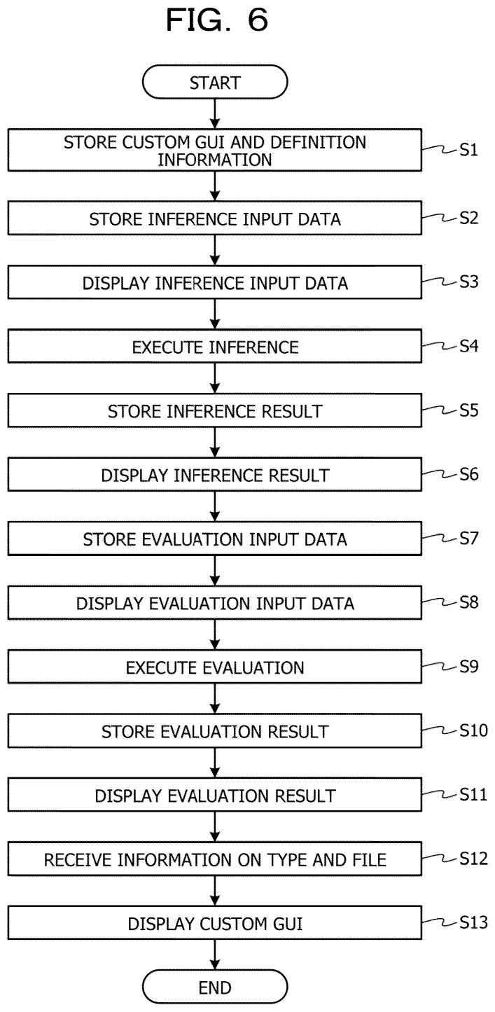

FIG. 6 is a flowchart of GUI display processing performed by the information processing apparatus according to Embodiment 1. Next, a flow of GUI display processing performed by the information processing apparatus 1 according to the present embodiment will be described with reference to FIG. 6.

The GUI data storage unit 101 receives input of data of a GUI to be used for machine learning including a custom GUI from the GUI development apparatus 3, and stores the data. The definition information storage unit 102 receives input of definition information of the custom GUI from the GUI development apparatus 3, and stores the definition information (step S1).

The input control unit 106 receives input of inference input data from the input device 22, and outputs the acquired inference input data to the data management unit 105. The data management unit 105 receives input of the inference input data from the input control unit 106, and stores the inference input data in the data storage unit 104 in accordance with the definition information related to inference input data stored in the definition information storage unit 102 (step S2).

Next, when information on the database, type, and file designating the file storing the stored inference input data is input, the display data determination unit 132 acquires definition information on the designated file from the definition information storage unit 102. The display data determination unit 132 specifies inference input data, a custom GUI to be the display destination, and a display method, which satisfy the condition designated by the definition information, and notifies the display control unit 131 thereof. The display control unit 131 receives the notification, and causes the display device 21 to display the designated inference input data in the designated custom GUI by the designated display method (step S3).

Next, the machine learning execution unit 107 receives input of an execution instruction of inference, acquires a machine learning model, inputs the inference input data stored in the data storage unit 104 to the machine learning model, and executes inference (step S4).

After that, the data management unit 105 stores inference result data output from the machine learning execution unit 107 in the data storage unit 104, in accordance with the definition information related to inference result data stored in the definition information storage unit 102 (step S5).

Next, when information on the database, type, and file designating the file storing the stored inference result data is input, the display data determination unit 132 acquires definition information on the designated file from the definition information storage unit 102. The display data determination unit 132 specifies inference result data, a custom GUI to be the display destination, and a display method, which satisfy the condition designated by the definition information, and notifies the display control unit 131 thereof. The display control unit 131 receives the notification, and causes the display device 21 to display the designated inference result in the designated custom GUI by the designated display method (step S6).

The input control unit 106 receives input of evaluation input data from the input device 22, and outputs the acquired evaluation input data to the data management unit 105. The data management unit 105 receives input of the evaluation input data from the input control unit 106, and stores the evaluation input data in the data storage unit 104 in accordance with the definition information related to evaluation input data stored in the definition information storage unit 102 (step S7).

Next, when information on the database, type, and file designating the file storing the stored evaluation input data is input, the display data determination unit 132 acquires definition information on the designated file from the definition information storage unit 102. The display data determination unit 132 specifies evaluation input data, a custom GUI to be the display destination, and a display method, which satisfy the condition designated by the definition information, and notifies the display control unit 131 thereof. The display control unit 131 receives the notification, and causes the display device 21 to display the designated evaluation input data in the designated custom GUI by the designated display method (step S8).

Next, the machine learning execution unit 107 receives input of an execution instruction of inference accuracy evaluation of the machine learning model, acquires the machine learning model, inputs the evaluation input data set stored in the data storage unit 104 to the machine learning model, and executes inference accuracy evaluation (step S9).

After that, the data management unit 105 stores evaluation result data output from the machine learning execution unit 107 in the data storage unit 104, in accordance with the definition information related to evaluation result data stored in the definition information storage unit 102 (step S10).

Next, when information on the database, type, and file designating the file storing the stored evaluation result data is input, the display data determination unit 132 acquires definition information on the designated file from the definition information storage unit 102. The display data determination unit 132 specifies evaluation result data, a custom GUI to be the display destination, and a display method, which satisfy the condition designated by the definition information, and notifies the display control unit 131 thereof. The display control unit 131 receives the notification, and causes the display device 21 to display the designated evaluation result in the designated custom GUI by the designated display method (step S11).

The input control unit 106 receives information on the selected specific type and specific file (step S12). The input control unit 106 outputs the received information on the specific type and specific file to the display data determination unit 132.

When the information on the specific type and specific file is input, the display data determination unit 132 acquires definition information on the designated file from the definition information storage unit 102. The display data determination unit 132 specifies data, a custom GUI to be the display destination, and a display method, which satisfy the condition designated by the definition information, and notifies the display control unit 131 thereof. The display control unit 131 receives the notification, and causes the display device 21 to display the designated data in the designated custom GUI by the designated display method (step S13).

As described above, the information processing apparatus according to the present embodiment manages data in a layered data structure that is made common to tasks. The information processing apparatus causes a GUI to display a layered data structure, and receives designation of data from a user who uses the GUI. The information processing apparatus holds definition information related to display of each piece of data in a custom GUI dependent on a task, and displays data designated in accordance with the definition information in the custom GUI.

A layered data structure is a general-purpose structure, and a GUI displaying the data structure may be made common to tasks. Processing of machine learning such as learning, inference, and evaluation is common to tasks, and input of execution instructions thereof may also be made common. For example, by using a general-purpose GUI for a portion in which a definition for display in a custom GUI is created for each task, a GUI may be created for managing the entire processing of machine learning for each task. Therefore, a GUI may be provided in which various tasks may be comprehensively handled and a custom screen may be added in order to meet individual needs, and convenience for an end user may be improved.

### EMBODIMENT 2

Next, Embodiment 2 will be described. An information processing apparatus 1 according to the present embodiment is also represented by the block diagram in FIG. 1. The information processing apparatus 1 according to the present embodiment includes, for a GUI to be used for machine learning, an application programming interface (API) for performing reading and writing of a setting value to be used for processing from and to the layers of datasets, types, and files.

By using the input device 22 and operating a GUI, a user inputs a setting value to the information processing apparatus 1 via the API in the target layer and performs writing of the setting value. For example, the user may use a representational state transfer (REST) API and perform input of a setting value.

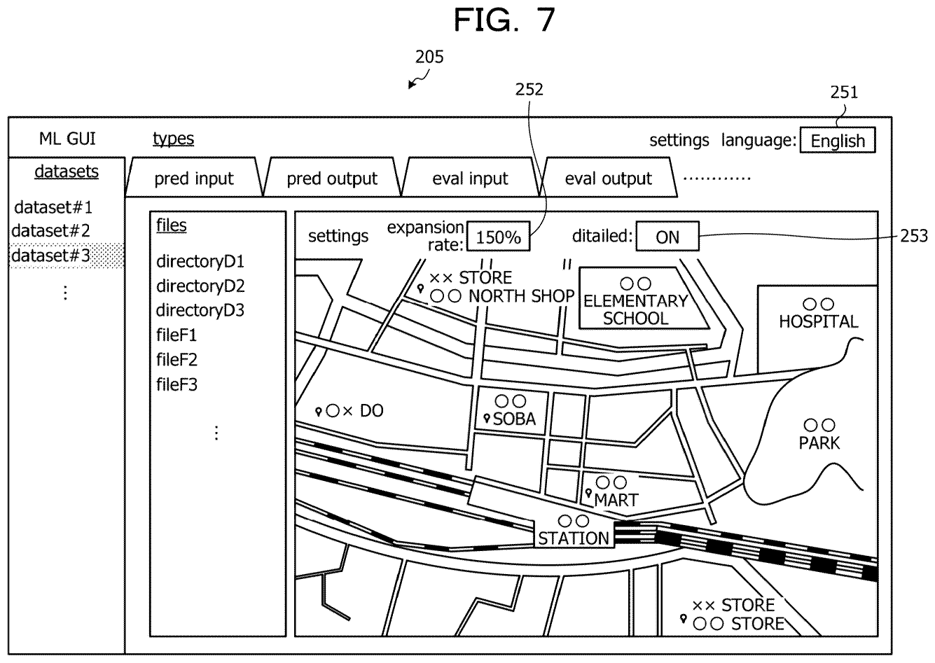

For example, the display control unit 131 displays a GUI 205 illustrated in FIG. 7. FIG. 7 is a diagram illustrating an example of change of setting values in a custom GUI according to Embodiment 2. The display control unit 131 causes the display device 21 to display the GUI 205 provided with a setting window 251 for changing language setting of the entire display, a setting window 252 for changing expansion rate in a custom GUI, and a setting window 253 for changing display granularity in the custom GUI.

The setting value in the setting window 251 is accessible via the API in the layer of datasets. The setting values in the setting windows 252 and 253 are accessible via the API in the layer of files.

For example, in a case of initial display of the GUI 205, the display control unit 131 displays a predetermined initial value in each of the setting windows 251 to 253. The display control unit 131 performs display of the GUI 205 in accordance with the initial values in the setting windows 251 to 253. For example, when the setting value in the setting window 251 is English, the display control unit 131 performs display of the GUI 205 in English as the display language. When the expansion rate in the setting window 252 is 150%, the display control unit 131 expands the displayed image by 150% and displays the image in the custom GUI. When the setting window 253 is ON, the display control unit 131 adds detailed information to the displayed image and performs display of the custom GUI.

The display control unit 131 reads and writes the setting values in the setting windows 251 to 253 via the API. When a setting value is input using the REST API, the display control unit 131 manages the setting value of each dataset, each type, and each file with the setting value of root as a starting point.

When input of a setting value of language setting is received from the input control unit 106 via the API for datasets, the display control unit 131 causes the input setting value to be displayed in the setting window 251 and changes the display language of the GUI 205 to the designated language. When input of a setting value of expansion rate is received from the input control unit 106 via the API for files, the display control unit 131 causes the input setting value to be displayed in the setting window 252 and changes the expansion rate of the image displayed in the custom GUI to the designated expansion rate. When input of a setting value of detailed display is received from the input control unit 106 via the API for files, the display control unit 131 causes the input setting value to be displayed in the setting window 253 and changes the display of the image displayed in the custom GUI to the designated display.

The setting windows 251 to 253 are an example of a “third display area”. For example, the display control unit 131 displays, by adding to the display screen, the third display area in which display of setting values for one or more of a plurality of layers and input of the setting values are received. The display control unit 131 edits display of the display screen based on the setting values input by the operation for the third display area.

As described above, the information processing apparatus according to the present embodiment acquires a setting value of a GUI to be used for machine learning via the API corresponding to each layer, and causes the setting to be displayed on the display. As described above, since the setting desired by a user may be applied to each layer, it is possible to flexibly display a custom GUI and the entire GUI.

### (Hardware Configuration)

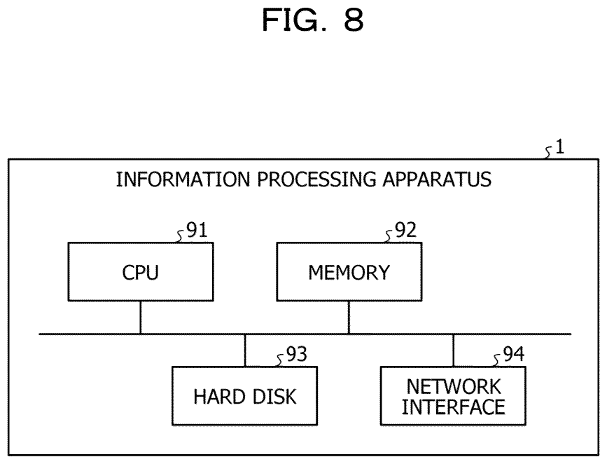

FIG. 8 is a hardware configuration diagram of the information processing apparatus. Next, description will be given with reference to FIG. 8 for an example of a hardware configuration for performing each function of the information processing apparatus 1.

As illustrated in FIG. 8, for example, the information processing apparatus 1 includes a central processing unit (CPU) 91, a memory 92, a hard disk 93, and a network interface 94. The CPU 91 is coupled to the memory 92, the hard disk 93, and the network interface 94 via a bus.

The network interface 94 is an interface for communication between the information processing apparatus 1 and an external apparatus. For example, the network interface 94 relays communication between the terminal apparatus 2 and the GUI development apparatus 3 and the CPU 91.

The hard disk 93 is an auxiliary storage device. The hard disk 93 performs the functions of the GUI data storage unit 101, the definition information storage unit 102, and the data storage unit 104, which are exemplified in FIG. 1. The hard disk 93 stores various programs including programs for performing the functions of the display processing unit 103 including the display control unit 131 and the display data determination unit 132, the data management unit 105, the input control unit 106, and the machine learning execution unit 107, which are exemplified in FIG. 1.

The memory 92 is a main storage device. For example, a dynamic random-access memory (DRAM) may be used as the memory 92.

The CPU 91 reads various programs from the hard disk 93, loads the programs to the memory 92, and executes the programs. Accordingly, the CPU 91 performs the functions of the display processing unit 103 including the display control unit 131 and the display data determination unit 132, the data management unit 105, the input control unit 106, and the machine learning execution unit 107, which are exemplified in FIG. 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute a process comprising:
managing data to be used for processing of machine learning by a layered data structure of a plurality of layers;
displaying a display screen that includes a first display area that is made common to a plurality of tasks in which designation of any one among one or a plurality of layer data groups included in each layer is received for the each layer, and a second display area that is an area for displaying lowermost layer data specified by designation of each layer data group and in which a display method is editable;
holding definition information that includes a display method of each piece of the lowermost layer data in the second display area; and
when lowermost layer data is designated, performing display in the second display area in accordance with the definition information based on the designated lowermost layer data.

2. The non-transitory computer-readable recording medium according to claim 1, wherein
data is managed in a layered data structure of a first layer, a second layer, and a third layer that is a lowermost layer, and
the display screen is displayed that includes the first display area that receives designation of any one among first layer data groups included in the first layer, designation of any one among second layer data groups included in the designated first layer data group in the second layer, and designation of the lowermost layer data included in the designated second layer data group in the third layer.

3. The non-transitory computer-readable recording medium according to claim 2, wherein
the first layer data groups are datasets for each task,
the second layer data groups are groups generated from classifications of data included in the datasets according to a kind of data, and
the lowermost layer data is data included in each of the classifications.

4. The non-transitory computer-readable recording medium according to claim 1 for causing the computer to execute a process comprising:
displaying, by adding to the display screen, a third display area in which display of setting values for one or more of the plurality of layers and input of setting values are received; and
editing display on the display screen based on the setting values input by operation for the third display area.

5. An information processing method comprising:
managing data to be used for processing of machine learning by a layered data structure of a plurality of layers;
displaying a display screen that includes a first display area that is made common to a plurality of tasks in which designation of any one among one or a plurality of layer data groups included in each layer is received for the each layer, and a second display area that is an area for displaying lowermost layer data specified by designation of each layer data group and in which a display method is editable;
holding definition information that includes a display method of each piece of the lowermost layer data in the second display area; and
when lowermost layer data is designated, performing display in the second display area in accordance with the definition information based on the designated lowermost layer data.

6. An information processing apparatus comprising:
a memory; and
a processor coupled to the memory and configured to:
manage data to be used for processing of machine learning by a layered data structure of a plurality of layers;
display a display screen that includes a first display area that is made common to a plurality of tasks in which designation of any one among one or a plurality of layer data groups included in each layer is received for the each layer, and a second display area that is an area for displaying lowermost layer data specified by designation of each layer data group and in which a display method is editable;
hold definition information that includes a display method of each piece of the lowermost layer data in the second display area; and
when lowermost layer data is designated, perform display in the second display area in accordance with the definition information based on the designated lowermost layer data.
